(19) United States
(12) Patent Application Publication
(10) Pub. No.: US 2007/0184218 A1
(43) Pub. Date: Aug. 9, 2007

(54) Thermal transfer paper

(76) Inventor: Ming-Chung Ching, Kaohsiung City (TW)

Correspondence Address: TROXELL LAW OFFICE PLLC, SUITE 1404, 5205 LEESBURG PIKE, FALLS CHURCH, VA, 22041, US

(21) Appl. No.: 11/349,161

(22) Filed: Feb. 8, 2006

(51) Int. Cl. B41M 5/40

(52) U.S. Cl. 428/32.78

(57) ABSTRACT

A thermal transfer paper is composed of a printing layer printed with a glossy graphic, an ink layer formed under the printing layer and a hot melt glue layer formed under the ink layer. When the thermal transfer paper is pressed thermally, the hot melt glue layer is to be softened to become viscous, able to adhere with a substrate tightly, enabling the thermal transfer paper to be transferred to become a bright and vivid finish.

### BACKGROUND OF THE INVENTION

1. Field of the Invention

This invention relates to a thermal transfer paper, particularly to one able to achieve a good adhesion and a bright graphic with good covering ability on a substrate.

2. Description of the Prior Art

As shown in FIGS. 1 and 2, a conventional thermal transfer paper 1 for leather is composed of an ink layer 13, a hot melt glue layer 14 with a proper thickness under the ink layer 13, an isolating agent layer 12 above the ink layer 13 and a protective film layer 11 above the isolating agent layer 12. The combination of the protective film layer 11 and the isolating agent layer 12 form a glossy enamel-like finish on the ink layer 13, able to protect graphics under it.

But, the quality of the conventional thermal transfer paper 1 is always affected by the quantity of the hot melt glue layer 14 and the ink layer 13. That is, if the amount of the hot melt glue layer 14 is too great and that of the ink layer 13 is less, the graphic is to become blurred owing to too less of white ink as a basis. On the contrary, if it is too much of the ink layer 13 and too less of the hot melt glue layer 14, it is to get a poor adhesion because of too less of the hot melt glue layer 14.

A conventional thermal transfer paper 1 has the following disadvantages.

1. Limited glue volume: because the hot melt glue layer 14 is merely a thin layer of resin, it cannot adhere on the substrate effectively. Moreover, the substrate able to be transferred is limited to velvet or leather.

2. Complicated structure of the thermal transfer paper: because a conventional thermal transfer paper needs the isolating layer 12 and the protective film layer 11, it always provides a very thick finish, not welcomed by users.

3. Because a graphic is printed on the ink layer 13 by silkscreen printing, it is uneasy to control the thickness, causing the conventional papers in inconstant thickness.

### SUMMARY OF THE INVENTION

The objective of this invention is to offer a thermal transfer paper.

The characteristics of the invention are a printing layer printed with a glossy graphic, an ink layer formed under the printing layer and a hot melt glue layer formed under the ink layer. When the thermal transfer paper is pressed thermally, the hot melt glue layer is to be softened to become viscous, able to adhere with a substrate tightly, enabling the thermal transfer paper to be transferred to become a bright and vivid finish.

### BRIEF DESCRIPTION OF DRAWINGS

This invention is better understood by referring to the accompanying drawings, wherein:

FIG. 1 is a magnified cross-sectional view of a conventional thermal transfer paper for leather;

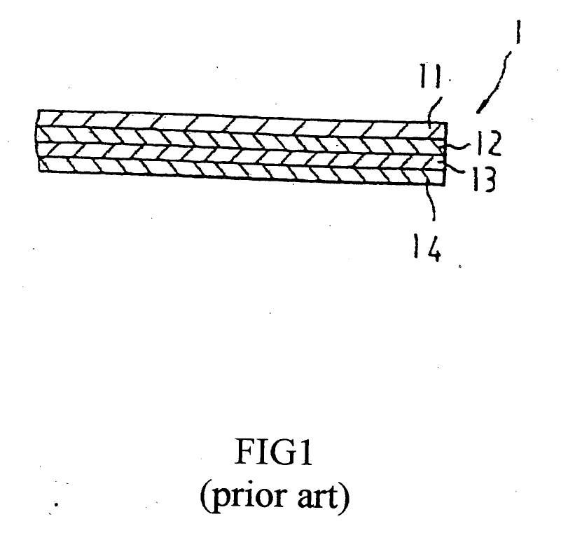

FIG. 2 is an exploded perspective view of a conventional thermal transfer paper for leather;

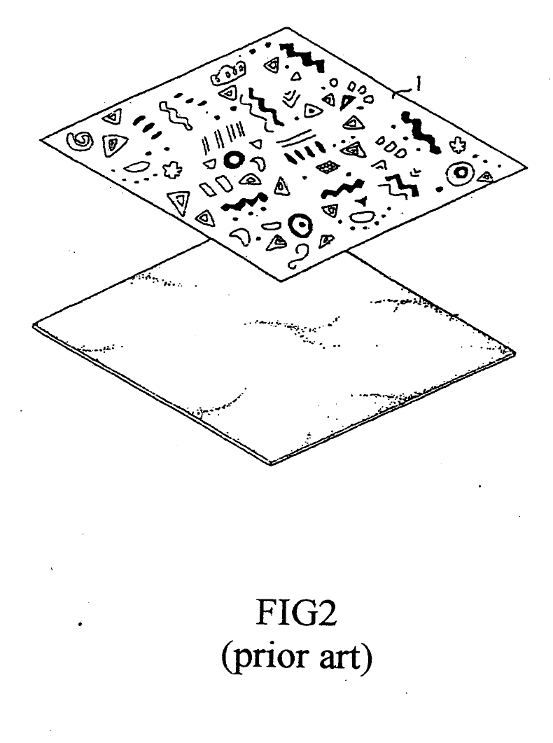

FIG. 3 is a cross-sectional view of a preferred embodiment of a thermal transfer paper in the present invention; and

FIG. 4 is a perspective view of the preferred embodiment of a thermal transfer paper in the present invention, showing it being transferred on a substrate.

### DETAILED DESCRIPTION OF THE PREFERRED EMBODIMENT

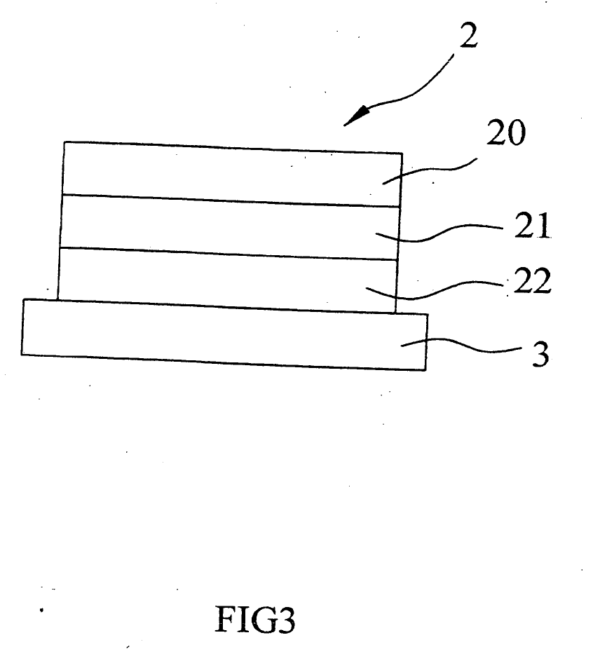

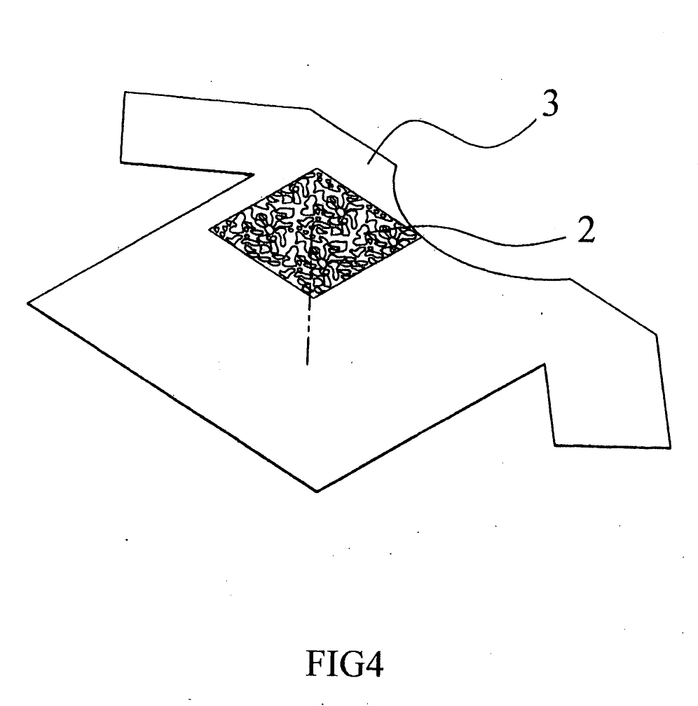

As shown in FIGS. 3 and 4, a preferred embodiment of a thermal heat transfer paper 2 in the present invention includes a printing layer 20, an ink layer 21 under the printed layer 20 and a hot melt glue layer 22 under the ink layer 21.

The printing layer 20 can be a layer printed with words or graphics by ink jet printing, silkscreen printing, offset printing or roller printing.

The ink layer 21 is preferably white ink based on polyurethane (PU) resin.

The hot melt glue layer 22 is to be softened to become viscous so as to adhere on a substrate 3 tightly while carrying out thermal transferring. The substrate 3 can be textile (such as a hat or clothes), leather or plastic.

The preferred ratio of the hot melt glue layer 22 and the ink layer 21 is 7:1.

In using, the hot melt glue layer 22 can adhere on the substrate 3 tightly to achieve an excellent adhesion. The ink layer 21 spread with an even white ink is able to make the graphic of the printing layer 20 look brighter and more vivid.

The present invention has following advantages as can be seen in the foresaid description.

1. The most proper viscosity and excellent transferring effect: the hot melt glue layer 22 is to be softened to achieve a very good adhesion and the printing layer 20 printed on the white ink layer 21 is to provide a bright and vivid graphic after thermal transferring.

2. A simple structure and fast transferring on a substrate: because the printing layer 20 is already printed with a graphic, so it can be directly transferred on the substrate 3, saving operating time.

3. A simple whole structure: since the present invention is simply composed of the printing layer 20, the ink layer 21 and the hot melt glue layer 22, it can achieve a rather thin final film.

While the preferred embodiment of the invention has been described above, it will be recognized and understood that various modifications may be made therein and the appended claims are intended to cover all such modifications that may fall within the spirit and scope of the invention.

What is claimed is:

1. A thermal transfer paper comprising:
a printing layer printed with words or graphics;
an ink layer formed under said printing layer and spread with an ink; and
a hot melt glue layer formed under said ink layer and able to be softened to adhere on a substrate tightly.

2. A thermal transfer paper as claimed in claim 1, wherein said substrate is textile.

3. A thermal transfer paper as claimed in claim 1, wherein said substrate is leather.

4. A thermal transfer paper as claimed in claim 1, wherein said substrate is plastic.

5. A thermal transfer paper as claimed in claim 1, wherein said printing layer is printed by ink jet printing.

6. A thermal transfer paper as claimed in claim 1, wherein said printing layer is printed by silkscreen printing.

7. A thermal transfer paper as claimed in claim 1, wherein said printing layer is printed by offset printing.

8. A thermal transfer paper as claimed in claim 1, wherein said printing layer is printed by roller printing.

9. A thermal transfer paper as claimed in claim 1, wherein the ink used for said ink layer is based on polyurethane.

10. A thermal transfer paper as claimed in claim 1, wherein the ratio of said hot melt glue layer and said ink layer is 7:1.
